(19) United States
(12) Patent Application Publication
(10) Pub. No.: US 2020/0001306 A1
(43) Pub. Date: Jan. 2, 2020

(54) FILTER ASSEMBLY WITH CHARGE ELECTRODES

(71) Applicant: HEWLETT-PACKARD DEVELOPMENT COMPANY, L.P., Spring, TX (US)

(72) Inventors: Ning Ge, 1501 Page Mill Road, CA (US); Paul Howard Mazurkiewicz, Fort Collins, CO (US); Helen A. Holder, Palo Alto, CA (US); Peter A. Seiler, Fort Collins, CO (US); Raphael Gay, Fort Collins, CO (US); Tom J. Searby, Fort Collins, CO (US)

(73) Assignee: HEWLETT-PACKARD DEVELOPMENT COMPANY, L.P., Spring, TX (US)

(21) Appl. No.: 16/486,134

(22) PCT Filed: Feb. 14, 2017
(86) PCT No.: PCT/US2017/017773

§ 371 Date: Aug. 14, 2019

(51) Int. Cl. B03C 3/155; B03C 3/41; B03C 3/68; B01D 46/00

(52) U.S. Cl. CPC B03C 3/155; B03C 3/41; B03C 2201/32; B01D 46/0086; B03C 2201/24; B03C 3/68

(57) ABSTRACT

In an example, an air filter assembly includes an air filter to remove particulates from air flowing through the air filter, sense electrodes coupled to the air filter, the sense electrodes spaced apart in a direction that is transverse to a direction of a flow of the air, a sense interconnects to couple the sense electrodes to a first power source to drive a sense electrode of the sense electrodes to a sense power, charge electrodes coupled to the air filter, where the charge electrodes are spaced apart from and adjacent to the sense electrodes, and charge interconnects to couple the charge electrodes to a second power source to drive a charge electrode of the charge electrodes to a charge power different from the sense power.

### BACKGROUND

Filters can be used in various types of electronic devices to remove or reduce particulates from fluid entering the electronic devices. For example, an electronic device can use a flow of air to perform convective heat transference. A filter can be placed in the path of an airflow to remove particulates from entering an inner chamber of the electronic device. In other examples, a filter can be used to remove particulates from a flow of liquid, such as water or other liquids.

### BRIEF DESCRIPTION OF THE DRAWINGS

FIG. 1 illustrates an example of a portion of an air filter assembly with charge electrodes in accordance with the disclosure.

FIG. 2 illustrates an example of an air filter assembly with charge electrodes in accordance with the disclosure.

FIG. 3 illustrates an example of an electronic device including an air filter assembly with charge electrodes in accordance with the disclosure.

FIG. 4 illustrates a flow diagram of an example of a method suitable with an air filter assembly with charge electrodes in accordance with the disclosure.

### DETAILED DESCRIPTION

A filter can be used in an electronic device to remove particulates from a flow of fluid. A fluid can refer to a gas (such as air or another type of gas) and/or a liquid (such as water or another type of liquid). Examples of electronic devices that can include filters to remove particulates from fluid include a server, a desktop, a laptop, a tablet, a mobile phone, a heating, ventilating, and air conditioning (HVAC) device, manufacturing or other industrial equipment, flow control equipment, an engine of a vehicle, a fluid filtration system, among other types of electronic devices. Examples of particulates include dust particles in air, debris in liquid, powder used in industrial equipment, shavings from milling or grinding equipment, biological materials (such as hair, skin cells, pollen, and other biological matter shed by plants and animals), and so forth.

A filter used in an electronic device may become clogged with particulates over time. For instance, as particulates on the filter increases over an operational lifetime of the filter, the filter may become less effective and/or the electronic device may not receive sufficient fluid flow from the filter to function as intended. For example, reduced fluid flow rate caused by a clogged filter may reduce a heat exchange or gas exchange capability of an electronic device.

Moreover, accumulation of particulates on a filter in an electronic device can pose risks to an environment around the electronic device, to humans who are using or in the proximity of the electronic device, and/or to the electronic device itself. Examples of risks to an electronic device caused by particulates include mechanical erosion or failure, chemical corrosion, electrical shorting, failure or damage caused by over-heating, or other risks. Examples of risks to humans in the proximity of the electronic device include electric shock from catastrophic failure of an electronic device due to over temperature events, exposure of humans to high levels of particulates, and so forth. For at least the above reasons, it may be desirable to determine when a filter is nearing the end of its useful operational life such as when the filter has become clogged or is nearing being clogged.

Accordingly, the disclosure is direct to an air filter assembly including a charge electrodes. As used herein, an air filter assembly refers to an air filter having sense electrodes and charge electrodes. For example, an air filter assembly can include an air filter to remove particulates from air flowing through the air filter, sense electrodes coupled to the air filter, the sense electrodes spaced apart in a direction that is transverse to a direction of a flow of the fluid, a sense interconnects to couple the sense electrodes to a first electrical bus to drive a sense electrode of the sense electrodes to a sense power, charge electrodes coupled to the air filter, where the charge electrodes are spaced apart from and adjacent to the sense electrodes, and charge interconnects to couple the charge electrodes to a second electrical bus to drive a charge electrode of the charge electrodes to a charge power different from the sense power.

Filter assemblies with charge electrodes can impart a charge (e.g., a negative charge) on particulates flowing through a filter included in the filter assembly to cause the charged particulates to selectively accumulate on a portion of the filter. For instance, the charged particulates can selectively accumulate on/near sense electrodes in proximity of the charge electrodes (e.g., when voltage and/or current is applied to the charge electrodes) to promote advance indication of when a filter is nearing an end of its useful life, as described herein.

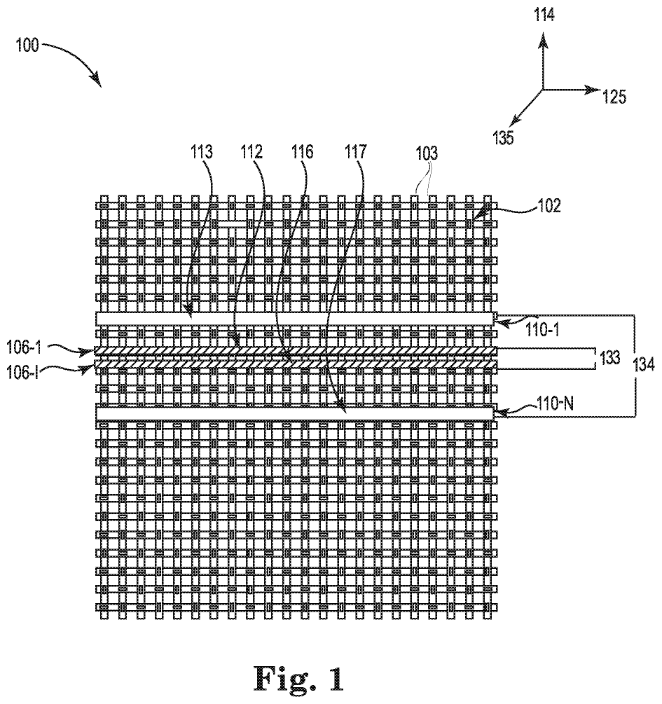

FIG. 1 illustrates an example of a portion of an air filter assembly 100 with charge electrodes 113, 117 in accordance with the disclosure. As illustrated in FIG. 1, the air filter assembly 100 includes an air filter 102, the charge electrodes 113, 117 illustrated as a first charge electrode 113 and a second charge electrode 117, sense electrodes 112, 116 illustrated as a first sense electrode 112 and a second sense electrode 116, a sense interconnect 106 illustrated as a first sense interconnect 106-1 and a second sense interconnect 106-I and a charge interconnect 110 illustrated as a first charge interconnect 110-1 and a second charge interconnect 110-N, among other components including those described herein.

The air filter assembly 100 can be coupled to an electronic device such as those electronic devices described herein. The air filter assembly 100, when coupled to an electronic device, is removable from an electronic device in which the air filter assembly 100 is included. Removal of the air filter assembly 100 can promote cleaning and/or replacement of the air filter assembly 100, for instance, in response to providing a notification to clean or replace the air filter assembly 100, as described herein.

The air filter 102 has filtering structures 103. The filtering structures can be in the form of a mesh with small openings between the filtering structures to allow fluid to pass through but which can trap particulates of greater than a specified size, or particulates small enough to be attracted to, and accumulate on the surface of the filtering structures. The filtering structures 103 can be part of a layer of a filtering medium, or multiple layers of filtering media. Although reference is made to the air filter 102 in the individual sense, it is noted that in further examples, the air filter assembly 100 can include multiple air filters.

The sense electrodes 112, 116 and the charge electrodes 113, 117 can be in the form of electrical conductors that are attached to and/or form filtering structures of the air filter 102. That is, in some examples, the sense electrodes 112, 116 and the charge electrodes 113, 117 can be integral with the filtering structures 103. However, in some examples, the sense electrodes 112, 116 and the charge electrodes 113, 117 can be separate and distinct conductors that are coupled to the filtering structures 103.

As illustrated in FIG. 1, the charge electrodes 112, 116 and the sense electrodes 112, 116 can each be positioned along the first axis 114 in a direction that is transverse to a direction of a flow of the fluid 135. A given direction is “transverse” to the direction of a fluid flow if the given direction is angled with respect to the direction of the fluid flow. The given direction is angled with respect to the direction of the fluid flow if the given direction has a non-zero angle with respect to the direction of the fluid flow. In some examples, the non-zero angle can be 90°, or can be between 45° and 90°, or can be between 30° and 90°, or can be between 20° and 90°, among other possibilities. Stated differently, in some examples, each electrode of the charge electrodes 113, 117 and the sense electrodes 112, 116 are positioned relative to each other in a plane extending in a direction that is traverse to a direction of a flow of the fluid.

However, the disclosure is not so limited. Rather, the relative position of the sense electrodes 112, 116 and the charge electrodes 113, 117 can be varied. For instance, while FIG. 1 illustrates the sense electrodes 112, 116 and the charge electrodes 113, 117 as being co-planar along the first axis 114 and/or along the second axis 125 the position of the charge electrodes may be varied such that the charge electrodes are ‘behind’ the sense electrodes along a third axis 135 that is substantially orthogonal to the first axis 114 and the second axis 125, among other possibilities. Although FIG. 1 illustrates the sense electrodes 112, 116 and charge electrodes 113, 117 as being spaced apart along the axis 114, it is noted that in other examples, the sense electrodes and/or the charge electrodes can be spaced apart along the second axis 125 which is perpendicular to the first axis 114. Alternatively, the sense electrodes 112, 116 and/or the charge electrodes 113, 117 may be spaced apart along both axes 114 and 125, such as along a diagonal axis, in a circular arrangement, in a rectangular arrangement, etc.

Regardless of the relative position of the electrodes, the sense electrodes 112, 116 are spaced apart from and adjacent to and the charge electrodes 113, 117. The charge electrodes 113, 117 are spaced apart along a first axis 114, such that a space 134 is provided between the charge electrodes 113, 117. Similarly, the sense electrodes are spaced apart along a first axis 114, such that a space 133 is provided between the sense electrodes 112, 116.

The sense electrodes 112, 116 may remain at a constant distance from each other over the entire length of the electrodes 112, 116, or the entire length of the sense electrodes 112, 116 that is exposed to particulates, or the distance may increase or decrease at various points along the length of the sense electrodes 112, 116. Similarly, the charge electrodes 113, 117 may remain at a constant distance from each other over the entire length of the charge electrodes 113, 117, or the entire length of the charge electrodes 113, 117 that is exposed to particulates, or the distance may increase or decrease at various points along the length of the charge electrodes 113, 117.

In various examples, the sense electrodes 112, 116 can be positioned in the space 134 between the charge electrodes 113, 117, as illustrated in FIG. 1. However, it is again noted that the disclosure is not so limited and other orientations such as having the charge electrodes ‘behind’ or in ‘front’ of the sense electrodes along the third axis 135 are possible.

As illustrated in FIG. 1, in some examples, the charge electrodes 113, 117 can be spaced apart from and adjacent to the first sense electrode 112 and the second sense electrode 116, respectively. Being ‘adjacent’ refers to an electrode being positioned next to another electrode without an intervening electrode between the electrodes. Being ‘adjacent’ does not imply physical contact between electrodes, Rather, ‘adjacent’ electrodes can be electrically isolated, That is, the charge electrodes 113, 117, can be adjacent to but electrically isolated from the sense electrodes 112, 116.

Particulates that are trapped by the air filter 102 can accumulate in the space 134 between the sense electrodes 112, 116 (as well as in other parts of the air filter 102), In some examples, the presence of accumulated particulates in the space 134 between the sense electrodes 112, 116 changes an electrical characteristic (e.g., electrical conductivity, inductance, and/or capacitance) between the sense electrodes 112, 116. That is, in some examples, the fluid that flows through the air filter 102 can be non-electrically conductive and/or have reduced electrical conductivity relative to an electroconductivity of the particulates. Stated differently, the particulates can be more electrically conductive than the fluid. As a result, the buildup of particulates in the space 134 causes the electrical conductivity of the space between the sense electrodes 112, 116 to change (e.g., increase), which can be detected by a sensor. A sensor, as described herein, can measure this electrical characteristic between the sense electrodes 112, 116 and provides an output based on the measured electrical characteristic. Furthermore, the electrical conductivity of the particulates may be influenced by environmental parameters such as ambient fluid temperature, relative humidity, and barometric pressure. The sensor can account for changes in environmental parameters when comparing a measured value of an electrical characteristic such as conductivity to another measured value of the electrical characteristic taken at a different time.

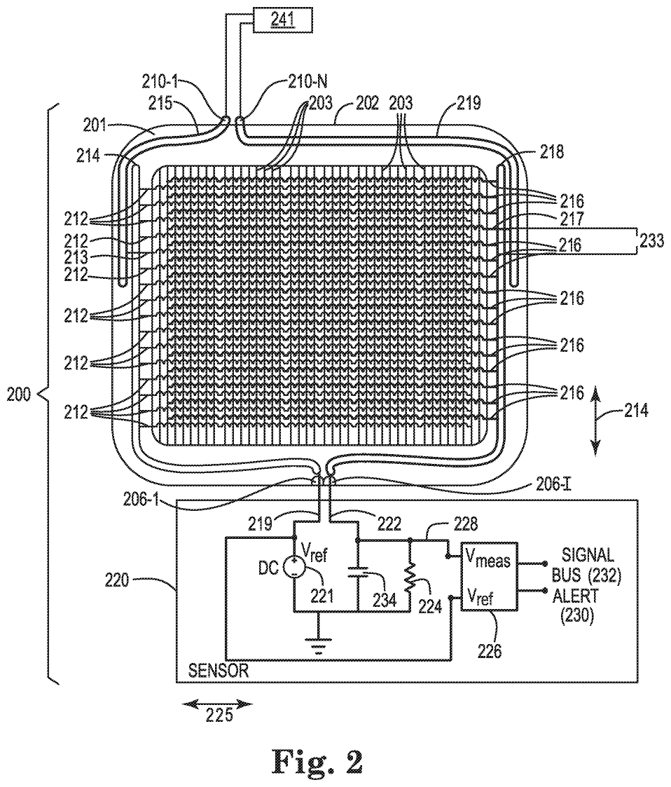

FIG. 2 illustrates an example of an air filter assembly with charge electrodes in accordance with the disclosure. The filter assembly 200 includes an air filter 202, a sensor 220 including a first power source 221, and a second power source 241.

The air filter 202 includes a support frame 201 that supports the filter including the filtering structures 203. FIG. 2 illustrates an interleaved arrangement of electrodes, where the interleaved arrangement of electrodes include reference electrodes 212 that are electrically connected to a reference bus 214, and sense electrodes 216 that are electrically connected to a measurement bus 218. A “bus” can refer to an electrical conductor. The reference bus 214 is connected to a reference node 219 of the sensor 220. The sensor 220 includes a first power source 221 (e.g., a direct current (DC) power source) which produces a reference voltage Vref and/or a reference current that is connected to the reference bus 214 through the reference node 219. Thus, the reference electrodes 212 are all driven to the reference voltage Vref and/or the reference current.

The measurement bus 218 is connected to a measurement node 222 of the sensor 220. In some examples, a switch (not shown) can be provided between the first power source 221 and the reference bus 214. The switch can be closed to connect Vref and/or the reference current to the reference bus 214 when measurement is to be performed, but can be opened to isolate the first power source 221 when measurement is not being performed. The sense electrodes 212, 216 are coupled via the sense interconnects 206-1 and 206-I to the reference bus 214 and the measurement bus 218. The first power source 221 can drive a sense electrode to a sense power (e.g., having a sense voltage and/or sense current) when measurement (e.g., of a conductivity across space 233) is being performed.

Although FIG. 2 shows the first power source 221 as being part of the sensor 220, in other examples, the first power source 221 is external of the sensor 220, but the reference voltage Vref output and/or reference current output by the external first power source 221 is connected to the reference node 219 of the sensor 220. Similarly, it is understood that the second power source 241 can be separate from but coupled to the air filter 202, for instance, coupled via the charge interconnects 210-1 and 210-N and buses 215, 219 of the support frame 201.

In various examples, the electrodes 212 and 216 are spaced apart from one another along first axis 214 of the air filter 202 and extend along the second axis 225, as illustrated in FIG. 2. The electrodes 212 and 216 are electrically isolated from one another. The spaces between the electrodes 212 and 216 span regions where particulates are expected to accumulate due to operation of the air filter 202.

In the interleaved arrangement of the electrodes 212 and 216 (referred to as a “filter sensor arrangement”), the reference electrodes 212 are alternately placed with respect to the sense electrodes 216, such that each respective reference electrode 212 is placed between two sense electrodes 216. The interleaved arrangement of electrodes 212 and 216 with respect of each other thus provides electrodes in the following sequence: reference electrode, sense electrode, reference electrode, sense electrode, and so forth. The space between a reference electrode 212 and an adjacent sense electrode 216 can initially be free of particulates, but over time as a result of operation of the air filter 202, particulates can accumulate in the space.

Collectively, the spaces between the reference electrodes 212 and the sense electrodes 216 make up an overall space whose electrical characteristic can be measured by the sensor 220. For example, if the measured electrical characteristic is conductivity and/or resistance, then as particulate buildup occurs in corresponding spaces between the reference electrodes 212 and sense electrodes 216, the sensor 220 is able to measure the overall resistance of the spaces (i.e., the resistance of the overall space measured by the sensor 220 is the parallel arrangement of resistances in the corresponding spaces).

In some examples, the electrodes 212 and 2166 may be arranged to measure the series resistance/conductivity of the overall space measured by the sensor 220, to measure the resistance between individual reference electrodes 212 and individual sense electrodes 216, to measure the resistance between subsets of the reference electrodes 212 and the sense electrodes (e.g., using multiplexers, a plurality of busses, etc.), or the like. The measured overall resistance may provide an average of the resistance due to particulate accumulation in the first portion and the resistance due to particulate accumulation in the second portion of the air filter 202.

As mentioned, particulates can selectively accumulate due to the charge imparted on the particles by the charge electrodes. For instance, particulates can selectively accumulate in a space 233 between sense electrodes. Notably, such selective accumulation can promote advance indication of when a filter is nearing an end of its useful life, for instance as compared to other approaches the rely solely on measuring a resistance of an overall space and/or those approaches that do not employ charge electrodes.

In addition to the first power source 221, the sensor 220 also includes a resistor 224 and a processor 226. The processor 226 includes a first input (referred to as a “Vmeas” input in FIG. 2) to receive a voltage of a node 228, and a second input (referred to as a “Vref” input in FIG. 2) to receive the reference voltage Vref from the first power source 221. In some examples, the processor 226 can include a comparator to compare a voltage at a node 228 to the reference voltage Vref. When the comparator determines that the voltage at the node 228 exceeds Vref, then the comparator outputs an alert 230, which can be provided to a computer. In some examples, the comparator may determine that the voltage at the node 228 exceeds a predetermined voltage, which may be used as a threshold to cause the comparator to output the alert 230.

The processor 226 can convert a voltage at the node 228 to a value (e.g., that represents an electrical conductivity across of the space 233 between the reference electrode 212 and sense electrodes 216 disposed therein). The value can be output over a signal bus 232 to the computer. In some examples, the processor 226 can simply output a value representing the voltage measured at the node 228 over the signal bus 232.

The resistor 224 of the sensor 220 and the resistance of the overall space between the reference electrodes 212 and sense electrodes 216 and/or resistance across of the space 233 to form a voltage divider. In some examples, the resistor 224 and the resistance of the air filter 202 can be part of a bridge circuit, such as a Wheatstone bridge. The node 228 can be the node between the air filter 202 and the filter space resistance. In some examples, the node 228 is the same as the node 222. An intervening circuit (such as a resistor) can be provided between the nodes 222 and 228. In some examples, the voltage divider can output a voltage that is based on an input voltage (in this case Vref) and a ratio of the resistor 224 and the resistance across a space of the air filter 202.

The voltage at the node 228 corresponds to an amount of accumulation of particulates at the air filter 202. For instance, node 228 can correspond to an amount of accumulation of particles in space 233, among other possibilities. A greater accumulation of particulates at the air filter 202 results in a lower resistance across a space in the filter and therefore may lead to a lower voltage at the node 228, for instance, when any changes in environmental conditions such as changes in humidity are accounted for (e.g., negated).

In some examples, the sensor 220 can also include a capacitor 234 connected between the node 228 and a common ground. The capacitor 234 can be used to filter noise signals, such as high-frequency noise signals, from the voltage at the node 228.

Although the sensor 220 has an example arrangement to measure a resistance of the space 233 and/or the overall space between the electrodes 212 and 216 (that form a filter sensor arrangement), in some examples, the sensor 220 can include circuitry to measure a capacitance and/or an inductance of the filter sensor arrangement.

Capacitance and inductance can be measured using the sensor described in FIG. 2 with some modifications. The measurement of capacitance and inductance employs a time-varying input signal, as opposed to a DC voltage provided by the first power source 221. This time-varying input signal can include a periodic signal such as a square wave or sine wave, or a non-periodic (within one measurement cycle) pulse signal. The response of the filter sensor arrangement to a time-varying signal (or to multiple time-varying input signals) can be measured with respect to time over some predetermined measurement period. The properties of the resulting waveform(s) are used to determine the inductance and/or capacitance of the overall space between the sense electrodes 212 and 216 for a respective level of particulate accumulation.

In some examples, a sine wave of known magnitude and phase can be applied in series to ground with any known combination of a resistor (e.g., resistor 224), a capacitor (e.g., the capacitor 234), and an inductor (not shown). The magnitude and phase of the output sine wave response of the circuit described above can be used to determine the impedance of the filter sensor arrangement, where the impedance is based on the combined effects of resistance, capacitance, and inductance of the filter sensor arrangement. The impedance of a capacitor is inversely proportional to the frequency of the applied sine wave multiplied by the capacitance, while the impedance of an inductor is directly proportional to the frequency of the applied sine wave multiplied by the inductance. The effect of the capacitance of the filter sensor arrangement on the impedance of the filter sensor arrangement can be differentiated from the effect of the inductance of the filter sensor arrangement on the impedance of the filter sensor arrangement by applying a further sine wave of a different frequency (or multiple further sine waves of different frequencies), and comparing the corresponding output sine wave response waveforms. The level of particulate accumulation of the filter sensor arrangement can therefore either be correlated to impedance and measured by applying only one sine wave, or, if correlated to capacitance or inductance individually, can be measured by applying two or more sine waves of different frequencies.

The electrical characteristic measured in a space across the electrodes (e.g., across sense electrodes 212 and 216 in space 233) by the sensor 220 can be a function not only of particulate accumulation, but also of temperature, barometric pressure, relative humidity and condensation. Therefore, a temperature sensor, a pressure sensor, and/or a humidity sensor can be added to the system, to allow for particulate accumulation to be more accurately inferred from the electrical characteristic measurement.

As illustrated in FIG. 2, the filter can be coupled to a second power source 241. The second power source 241 can include a current source and/or a voltage source to drive the charge electrodes 213, 217 to a charge power. For example, the second power source 241 can be coupled via charge interconnects 210-1 and 210-N to a reference charge bus 215 and a selectively charged bus 219.

In some examples, a switch (not shown) can be provided between a second power source 241 and the reference charge bus 215. The switch can be closed to connect a voltage and/or current provided by the second power source to the reference bus 214 when the charge electrodes are selectively charged, but can be opened to isolate the second power source 241 when the charge electrodes 213 and/or 217 are not being selectively is not being performed. The sense electrodes 212, 216 are coupled via the sense interconnects 206-1 and 206-I to the reference bus 214 and the measurement bus 218. The first power source 221, respectively, drive a sense electrodes to a sense power (e.g., having a sense voltage and/or sense current) when measurement (e.g., of a conductivity across space 233) is being performed. As mentioned, the second power source 241 and the first power source 221 can be a DC power source; however, in some examples, the second power source 241 and/or the first power source 221 can be an alternating current (AC) power source.

In some examples, the charge electrodes 213 and 217 can be positioned at a location off-center on the air filter 202 to attract particulates to the off-center location rather than to other portions of the air filter 202 further away from the charge electrodes. For instance, a negative charge can be imparted on particulates in proximity but not in contact with the air filter and such negatively charged particulates can be selectively attracted to an off-center location rather than other portions of the air filter 202.

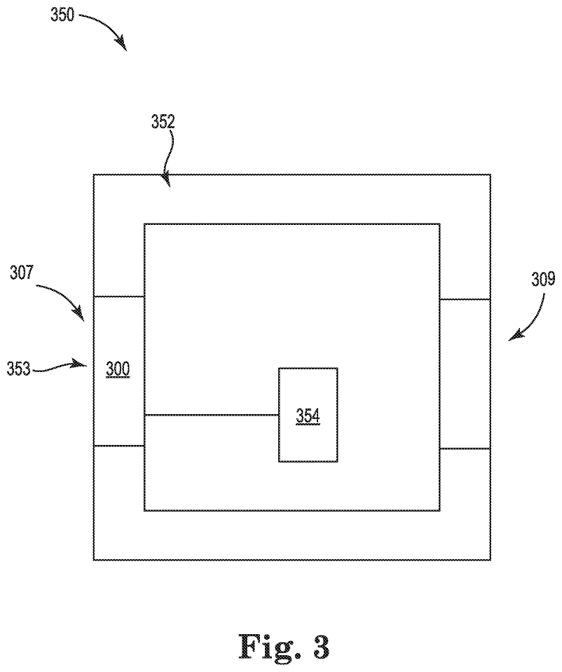

FIG. 3 illustrates an example of an electronic device 350 including an air filter assembly 300 with charge electrodes in accordance with the disclosure. As illustrated in FIG. 3, the electronic device 350 can include a housing 352, and a controller 354.

As illustrated in FIG. 3, the electronic device 350 includes a housing 352 forming at least a portion of an exterior surface of the electronic device 350. The housing 352 can be comprised of metal, plastic, and/or various composite materials, among other suitable materials, The housing 352 can house various components. For instance, each of the air filter assembly 300 and a controller 354 can be housed in the housing 352 although other configurations are possible.

As mentioned, an air filter included in the air filter assembly is positioned to remove particulates from air 353 or other fluid flowing through the air filter. For example, the air filter of the air filter assembly 353 can be positioned on an air inlet 307 and/or can be positioned at an air outlet 309 of the electronic device 350.

The electronic device 350 can be a server, a desktop, a laptop, a tablet, a mobile phone, a heating, ventilating, and air conditioning (HVAC) device, manufacturing or other industrial equipment, flow control equipment, an engine of a vehicle, a fluid filtration system, among other types of electronic devices. For instance, in some examples, the electronic device can be server, desktop, laptop, tablet, or a mobile phone.

The controller 354 refers to a hardware logic device (e.g., a logic die, application-specific integrated circuit (ASIC), etc. that can execute non-transitory instructions to perform various operations related to an air filter assembly with charge electrodes. The controller 354 can include hardware components such as a hardware processor (e.g., analogous to or different than processor 226 illustrated in FIG. 2) and/or computer-readable and executable non-transitory instructions to perform various operations related to an air filter assembly with charge electrodes. The computer-readable and executable non-transitory instructions (e.g., software, firmware, programming, etc.) may be stored in a memory resource (e.g., computer-readable medium) or as a hard-wired program (e.g., logic) included in and/or coupled to the controller 354.

The hardware processor (not shown), as used herein, can include a hardware processor capable of executing instructions stored by a memory resource. A hardware processor can be integrated in an individual device or distributed across multiple devices. The instructions (e.g., computer-readable instructions (CRI)) can include instructions stored on the memory resource and executable by the hardware processor to implement a desired function (e.g., instructions executable by the hardware processor to drive a charge electrode to a charge power, etc.).

A memory resource, as used herein, includes a memory component capable of storing non-transitory instructions that can be executed by a hardware processor. A memory resource can be integrated in an individual device or distributed across multiple devices. Further, memory resource can be fully or partially integrated in the same device as a hardware processor or it can be separate but accessible to that device and the hardware processor.

The memory resource can be in communication with a hardware processor via a communication link (e.g., path). The communication link can be local or remote to an electronic device associated with a hardware processor. Examples of a local communication link can include an electronic bus internal to an electronic device where the memory resource is one of volatile, non-volatile, fixed, and/or removable storage medium in communication with a hardware processor via the electronic bus.

In some examples, the controller 354 can include instructions executable by a processing resource to cause the first power source to drive a sense electrode of the sense electrodes to a sense power and/or can cause a second electrical bus to drive a charge electrode of the charge electrodes to a charge power that is different than the sense power. For instance, the controller can cause a switch positioned between a first power source and/or a second power source to be opened or closed to vary an amount of power supplied to a charge electrode and/or an amount of power supplied to a sense electrode.

In some examples, the charge power can be one volt or greater. For example, the charge power can be a voltage in a range from one 1 volt to 48 volts and/or a current in a range from 1 nanoampere to 1 ampere, among other possibilities. All individual values and subranges within the charge power range are included. In some examples, the sense power can be 0.1 volts or greater. For example, the sense power can be a voltage in a range from 0.1 volts to 48 volts and/or can be a current in a range from 1 picoampere to 1 milliampere, among other possibilities. Again, it is understood all individual values and subranges within the range are included. Notably, in various examples, the charge power is different than a sense power. For instance, the charge power can be greater than a sense power. In some examples, effectiveness as measured in terms of localized particulate accumulation at or near the charge electrodes may be increased along with increased charge power (increased voltage and/or current). Charge power above 48 volts and/or above 1 ampere is possible, particularly in housing including electrical insulation and/or other components to promote charge power having a voltage above 48 volts and/or a current above 1 ampere. In some examples, the charge power can be varied to target particular types of particulates and/or particulate sizes (e.g., based on diameter). In this manner, such targeted particulates can, in some examples, be selectively attracted to the charge electrodes at a rate that is greater than other non-targeted particulates.

In some examples, the charge power can a negative voltage to drive the charge electrodes to a negative potential. In this manner, the charge electrodes when driven to a negative potential can impart a negative charge on particulate flowing through the air filter.

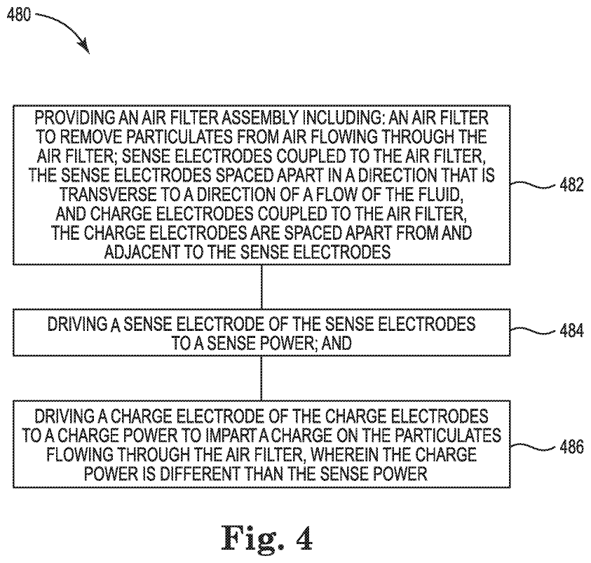

FIG. 4 illustrates a flow diagram of an example of a method suitable with an air filter assembly with charge electrodes in accordance with the disclosure. As illustrated at 482, the method 480 can include providing an air filter assembly. As used herein, providing refers to installation of the air filter assembly into a housing of an electronic device. For instance, the method 480 can include providing an air filter assembly including an air filter to remove particulates from air flowing through the air filter, sense electrodes coupled to the air filter, the sense electrodes spaced apart in a direction that is transverse to a direction of a flow of the fluid, and charge electrodes coupled to the air filter, as described herein. As mentioned, in some examples, the charge electrodes can be spaced apart from and adjacent to the sense electrodes.

The method 480 can include driving a sense electrode of the sense electrodes to a sense power, as illustrated at 484. For example, driving the sense electrode to the sense power can include closing a switch and/or supplying power from a first power supply, as described herein. The method 480 can include driving a charge electrode of the charge electrodes to a charge power to impart a charge on the particulates flowing through the air filter, as illustrated at 486. For example, driving the charge electrode to the charge power can include closing a switch and/or supplying power from a second power supply, as described herein.

In some examples, the method 480 can include continuously driving the charge electrodes (in contrast to other approaches that may intermittently or otherwise non-continuously drive electrodes in or near a filter to a given voltage/current) to the charge power during operation of an electronic device including the air filter assembly to attract particulates to and/or near the charge electrodes. However, the charge electrodes can be selectively driven non-continuously at a given interval and/or in response to an input such as those from a user of an electronic device having a filter assembly including the charge electrodes, among other possibilities. In either the continuous or non-continuous examples, it is noted the charge electrodes can be driven to a charge power (having a value that is different than a sense power) at that same time the sense electrodes are driven to the sense voltage to promote measuring of an electrical characteristic, selective accumulation of particles near the charge electrodes, and/or other aspects of air filter assemblies with charge electrodes, as described herein.

In some examples, the method can include causing a first electrical bus to drive a sense electrode of the sense electrodes to the sense power without the first electrical bus providing a power to the charge electrodes. That is, the sense electrodes can be driven to a sense power by a first power supply whereas the charge electrodes can be driven to a charge power by a second power supply.

In some examples, the method 480 can include measuring, via a sensor coupled to the sense electrodes, an electrical characteristic. As mentioned, measuring can include measuring the electrical characteristic as an electrical conductivity, a capacitance, and/or an inductance of a space between the sense electrodes, among other possibilities.

The method 480 can include providing a notification to clean or replace the air filter assembly when the measured characteristic meets or exceeds a threshold such as a conductivity/resistance threshold, Conductivity refers to the degree to which a material (such as air/particulates in a space between the sense electrodes) conduct electricity. It may be the reciprocal of resistivity. The notification can be provided via a display of an electronic device (e.g., laptop) housing the air filter assembly. In this manner, a user of the electronic device can be notified, among other possibilities. The notification can promote removal and replacement of an air filter assembly or cleaning of an air filter assembly.

The figures herein follow a numbering convention in which the first digit corresponds to the drawing figure number and the remaining digits identify an element or component in the drawing. For example, reference numeral 106 can refer to element “06” in FIG. 1 and an analogous and/or identical element can be identified by reference numeral 206 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It is understood that when an element is referred to as being “on,” “connected to”, “coupled to”, or “coupled with” another element, it can be directly on, connected to, or coupled with the other element or intervening elements can be present. “Directly” coupled refers to being connected without intervening elements. As used herein, “logic” is an alternative or additional processing resource to execute the actions and/or functions, etc., described herein, which includes hardware (e.g., various forms of transistor logic, ASICs, etc.), as opposed to computer executable instructions (e.g., software, firmware, etc.) stored in memory and executable by a processing resource.

What is claimed:

1. An air filter assembly, comprising:
an air filter to remove particulates from air flowing through the air filter;
sense electrodes coupled to the air filter, the sense electrodes spaced apart in a direction that is transverse to a direction of a flow of the air;
a sense interconnects to couple the sense electrodes to a first power source to drive a sense electrode of the sense electrodes to a sense power;
charge electrodes coupled to the air filter, wherein the charge electrodes are spaced apart from and adjacent to the sense electrodes; and
charge interconnects to couple the charge electrodes to a second power source to drive a charge electrode of the charge electrodes to a charge power different from the sense power.

2. The air filter assembly of claim 1, wherein the sense electrodes include a first sense electrode and a second sense electrode, and wherein the charge electrodes include a first charge electrode and a second charge electrode spaced apart from and adjacent to the first sense electrode and the second sense electrode, respectively.

3. The air filter assembly of claim 1, wherein the charge electrodes are positioned at a location off center on the air filter to attract particulates to the off-center location.

4. The air filter assembly of claim 1, including a sensor coupled to the sense electrodes to measure an electrical characteristic of a space between the sense electrodes, wherein the measured electrical characteristic varies depending upon an amount of particulates in the space.

5. The air filter assembly of claim 1, wherein the sense electrodes comprise interleaved first sense electrodes and second sense electrodes, and wherein a respective first sense electrode of the first sense electrodes is positioned between adjacent second sense electrodes of the second sense electrodes.

6. The air filter assembly of claim 1, wherein the charge electrodes and the sense electrodes are each positioned along a first axis that is transverse to a direction of a flow of the air.

7. The air filter assembly of claim 1, wherein the charge electrodes are positioned relative to the sense electrodes in a plane substantially orthogonal to a flow of the air.

8. An electronic device comprising:
a housing; and
an air filter assembly coupled to the housing, the air filter assembly including:
an air filter;
sense electrodes coupled to the air filter, the sense electrodes spaced apart in a direction that is transverse to a direction of a flow of the fluid; and
charge electrodes coupled to the air filter, wherein the charge electrodes are spaced apart from and adjacent to the sense electrodes;
a first power source coupled to the sense electrodes;
a second power source coupled to the charge electrodes; and
a controller coupled to the housing, the controller to:
cause the first power source to drive a sense electrode of the sense electrodes to a sense power; and
cause a second electrical bus to drive a charge electrode of the charge electrodes to a charge power that is different than the sense power.

9. A method comprising:
providing an air filter assembly including:
an air filter to remove particulates from air flowing through the air filter;
sense electrodes coupled to the air filter, the sense electrodes spaced apart in a direction that is transverse to a direction of a flow of the fluid: and
charge electrodes coupled to the air filter, wherein the charge electrodes are spaced apart from and adjacent to the sense electrodes;
driving a sense electrode of the sense electrodes to a sense power; and
driving a charge electrode of the charge electrodes to a charge power to impart a charge on the particulates flowing through the air filter, wherein the charge power is different than the sense power.

10. The method of claim 9, including driving the charge electrodes to a negative charge power to impart a negative charge on the particulates flowing through the air filter.

11. The method of claim 9, including measuring, via a sensor coupled to the sense electrodes, an electrical characteristic and providing a notification to clean or replace the air filter when the measured characteristic meets or exceeds a threshold.

12. The method of claim 11, wherein the measuring further comprises measuring the electrical characteristic as an electrical conductivity, a capacitance, or an inductance of a space between the sense electrodes.

13. The method of claim 9, including continuously driving the charge electrodes to the charge power during operation of an electronic device including the air filter assembly.

14. The method of claim 9, further comprising causing a first electrical bus to drive a sense electrode of the sense electrodes to the sense power without the first electrical bus providing a power to the charge electrodes.

15. The method of claim 9, including intermittently driving the charge electrodes to the charge power during operation of an electronic device including the air filter assembly.
